(19) United States
(12) Patent Application Publication
(10) Pub. No.: US 2023/0255424 A1
(43) Pub. Date: Aug. 17, 2023

(54) ROBOT CLEANER AND METHOD FOR CONTROLLING SAME

(71) Applicant: LG ELECTRONICS INC., Seoul (KR)

(72) Inventors: Changhyeon LEE, Seoul (KR); Jaeheon CHUNG, Seoul (KR); Kihong PARK, Seoul (KR)

(21) Appl. No.: 18/017,162

(22) PCT Filed: Dec. 9, 2020
(86) PCT No.: PCT/KR2020/017966

§ 371 Date: Jan. 20, 2023

(30) Foreign Application Priority Data
Jul. 22, 2020 (KR) 10-2020-0090975

(51) Int. Cl. A47L 9/28; A47L 11/40; A47L 11/28; G05D 1/02

(52) U.S. Cl. CPC A47L 9/2826; A47L 9/2847; A47L 9/2842; A47L 9/2852; A47L 11/4011; A47L 11/28; A47L 11/4066; G05D 1/0274; G05D 1/0251; A47L 2201/06; A47L 2201/04; G05D 2201/0203; G05D 2201/0215

(57) ABSTRACT

Disclosed are a robot cleaner and a method for controlling same, and the method for controlling a robot cleaner, according to one embodiment of the present invention, comprises: a floor mapping step in which a robot cleaner drives in an area to be cleaned and collects information about the floor surface; a cleaning planning step in which a cleaning plan of the robot cleaner is determined on the basis of the collected information about the floor surface; and a robot control step in which, once the cleaning plan is determined, the robot cleaner is controlled to drive and clean according to the cleaning plan.

### TECHNICAL FIELD

The present disclosure relates to a robot cleaner and a method for controlling the same.

### BACKGROUND

Humans clean their living spaces for hygiene and cleanliness. There may be many reasons for the cleaning. For example, the cleaning is performed to protect a body from disease or to prevent damage to a bronchus, and the cleaning is performed for quality of life, such as to clean a space one is in.

Dust or a foreign substance settles to a floor by gravity. Therefore, in order to perform the cleaning, people bend their backs or sit down, so that people tend to strain their backs or joints.

Because of such problem, recently, cleaners that help people perform the clean have appeared. Types of cleaners may be roughly classified into handy stick cleaners, bar-type cleaners, or robot cleaners.

Among those, the robot cleaner cleans a space instead of a user in a specific space such as home or office. The robot cleaner generally performs the cleaning by sucking dust from an area-to-be-cleaned.

Referring to Korean Patent Publication Application No. 10-2013-0091879, a process of generating a map containing information on a space-to-be-cleaned, a process of setting a cleaning route using the map, and a process of performing the cleaning using the cleaning route are disclosed, but there is no disclosure of contents of utilizing information on a floor on which the robot cleaner substantially travels, such as performing the cleaning by analyzing a shape or a depth of a floor surface.

### SUMMARY

### Technical Problem

Embodiments of the present disclosure are to provide a robot cleaner and a method for controlling the same that create an efficient cleaning route by determining a shape or a material of a floor surface.

In addition, embodiments of the present disclosure are to provide a robot cleaner and a method for controlling the same in which rotation of an agitator roller, a side brush, and the like may be controlled differently depending on a type of floor surface when the robot cleaner is operated.

In addition, embodiments of the present disclosure are to provide a robot cleaner and a method for controlling the same that may distinguish between a cleanable area and a non-cleanable area in consideration of an inclined area, a stepped area, or an area where a carpet is disposed.

In addition, embodiments of the present disclosure are to provide a robot cleaner and a method for controlling the same that may exclude an area that is not able to be reached or from which exit is impossible after entry from an area-to-be-cleaned such that the robot cleaner may finish cleaning normally.

In addition, embodiments of the present disclosure are to provide a robot cleaner and a method for controlling the same that may not interfere with use of other electronic products while the robot cleaner travels.

### Technical Solutions

One embodiment of the present disclosure provides a method for controlling a robot cleaner capable of collecting information on a floor surface using a depth camera and performing cleaning based on the information on the floor surface.

In addition, one embodiment of the present disclosure provides a method for controlling a robot cleaner in which an operating scheme of the robot cleaner varies depending on a type or a material of a floor surface.

In addition, one embodiment of the present disclosure provides a method for controlling a robot cleaner capable of performing efficient cleaning by creating a floor map for each time slot when necessary.

More specifically, according to one embodiment, provided is a method for controlling a robot cleaner including a floor mapping step for the robot cleaner to collect information on a floor surface while traveling in an area-to-be-cleaned, a cleaning plan establishment step for determining a cleaning plan of the robot cleaner based on the collected information on the floor surface, and a robot control step for controlling the robot cleaner to perform cleaning while traveling based on the cleaning plan when the cleaning plan is determined.

In addition, provided is the method for controlling the robot cleaner in which, in the floor mapping step, the information on the floor surface is collected by sensing means including a light source for irradiating light and a sensor for sensing reflection of the light irradiated from the light source.

In addition, provided is the method for controlling the robot cleaner in which the floor mapping step includes an area-to-be-intensively-cleaned determination step for determining an area-to-be-intensively-cleaned where a suction force of the robot cleaner required for the cleaning is great.

In addition, provided is the method for controlling the robot cleaner in which the area-to-be-intensively-cleaned includes at least one of a corner, a crevice, and a carpet existing in the area-to-be-cleaned.

In addition, provided is the method for controlling the robot cleaner in which, in the robot control step, the robot cleaner is controlled such that the suction force is great in the area-to-be-intensively-cleaned.

In addition, provided is the method for controlling the robot cleaner in which the floor mapping step includes a cleaning-impossible-area determination step for determining a cleaning-impossible-area where the cleaning of the robot cleaner is limited in the area-to-be-cleaned.

In addition, provided is the method for controlling the robot cleaner in which the robot cleaner includes suction means for sucking dust on the floor surface and a side brush module for scattering dust on the floor surface, and the cleaning-impossible-area includes at least one of a travel-impossible-area where the robot cleaner is not able to travel and an obstacle area where an obstacle limiting operation of the side brush module is disposed.

In addition, provided is the method for controlling the robot cleaner in which the cleaning plan establishment step includes a cleaning route determination step for generating a cleaning route of the robot cleaner, and, when the cleaning-impossible-area is determined, the cleaning-impossible-area is controlled to be excluded when the cleaning route of the robot cleaner is generated in the cleaning plan establishment step.

In addition, provided is the method for controlling the robot cleaner in which the robot cleaner includes a wet cleaning module capable of performing wet cleaning, and the floor mapping step includes a wet cleaning-impossible-area determination step for determining a wet cleaning-impossible-area, an area where the wet cleaning is impossible.

In addition, provided is the method for controlling the robot cleaner in which the wet cleaning-impossible-area includes at least one of an area with electric wires and an area with a carpet.

In addition, provided is the method for controlling the robot cleaner in which the cleaning plan establishment step includes a cleaning route determination step for generating a cleaning route of the robot cleaner, and the cleaning route is newly determined each time the cleaning is performed.

In addition, provided is the method for controlling the robot cleaner in which the cleaning route is determined differently depending on a cleaning time slot.

In addition, provided is the method for controlling the robot cleaner in which the cleaning plan establishment step includes an area-to-be-climbed determination step for determining an area-to-be-climbed, an area to be climbed by the robot cleaner while traveling, in the area-to-be-cleaned.

In addition, provided is the method for controlling the robot cleaner in which the cleaning route determination step determines a cleaning route based on a location of the area-to-be-climbed.

### Advantageous Effects

Embodiments of the present disclosure may provide the robot cleaner and the method for controlling the same that enable the smooth travel of the robot cleaner by determining the area-to-be-climbed in advance.

In addition, embodiments of the present disclosure may provide the robot cleaner and the method for controlling the same that may perform the cleaning by avoiding the area where a large number of electric wires are placed, so that other electronic products in the area-to-be-cleaned may operate normally.

In addition, embodiments of the present disclosure may provide the robot cleaner and the method for controlling the same that may prevent contamination of the area where the wet cleaning is not to be performed as the wet cleaning-impossible-area is separately mapped.

In addition, embodiments of the present disclosure may provide the robot cleaner and the method for controlling the same that may efficiently use the battery as the efficient cleaning is performed.

### BRIEF DESCRIPTION OF THE DRAWINGS

FIG. 1 is a diagram showing a robot cleaner according to one embodiment.

FIG. 2 is a diagram showing a portion of a bottom surface of a robot cleaner according to one embodiment.

FIG. 3 is a block diagram showing a configuration of a robot cleaner according to one embodiment.

FIG. 4 is a diagram showing a method for controlling a robot cleaner according to one embodiment.

FIG. 5 is a diagram specifically showing a floor mapping step of a method for controlling a robot cleaner according to one embodiment.

FIGS. 6 (a) and (b) are diagrams showing a method for determining a material of a floor surface according to one embodiment.

FIG. 7 is a diagram showing a cleaning plan establishment step of a robot cleaner according to one embodiment.

### DETAILED DESCRIPTION

Hereinafter, an embodiment of the present disclosure will be described in detail with reference to the accompanying drawings such that a person having ordinary knowledge in the technical field to which the present disclosure belongs may easily implement the embodiment.

However, the present disclosure is able to be implemented in various different forms and is not limited to the embodiment described herein. In addition, in order to clearly describe the present disclosure, components irrelevant to the description are omitted in the drawings. Further, similar reference numerals are assigned to similar components throughout the present disclosure.

Duplicate descriptions of the same components are omitted herein.

In addition, it will be understood that when a component is referred to as being ‘connected to’ or ‘coupled to’ another component herein, it may be directly connected to or coupled to the other component, or one or more intervening components may be present. On the other hand, it will be understood that when a component is referred to as being ‘directly connected to’ or ‘directly coupled to’ another component herein, there are no other intervening components.

The terminology used herein is for the purpose of describing the embodiments of the present disclosure only and is not intended to be limiting of the present disclosure.

As used herein, the singular forms ‘a’ and ‘an’ are intended to include the plural forms as well, unless the context clearly indicates otherwise.

It should be understood that the terms ‘comprises’, ‘comprising’, ‘includes’, and ‘including’ when used herein, specify the presence of the features, numbers, steps, operations, components, parts, or combinations thereof described herein, but do not preclude the presence or addition of one or more other features, numbers, steps, operations, components, or combinations thereof.

In addition, herein, the term ‘and/or’ includes a combination of a plurality of listed items or any of the plurality of listed items. Herein, ‘A or B’ may include ‘A’, ‘B’, or ‘both A and B’.

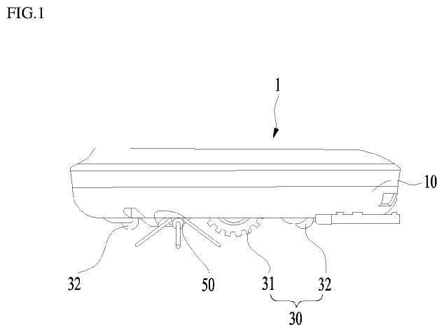

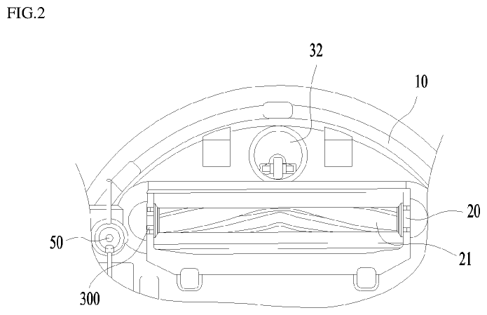

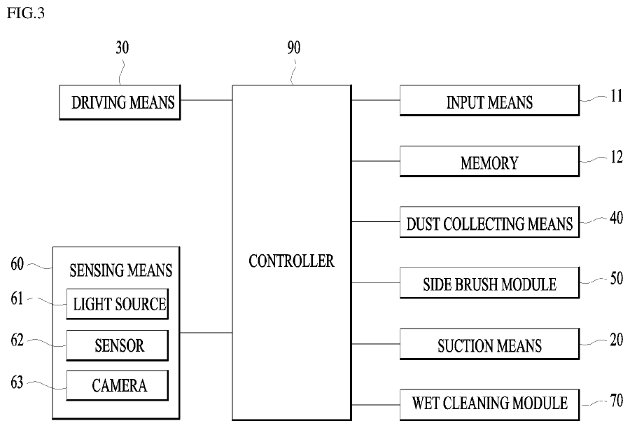

FIG. 1 is a diagram showing a robot cleaner according to one embodiment, FIG. 2 is a diagram showing a portion of a bottom surface of a robot cleaner according to one embodiment, and FIG. 3 is a block diagram showing a configuration of a robot cleaner according to one embodiment.

Referring to FIGS. 1 to 3, a robot cleaner 1 performs a function of cleaning a floor while traveling in a certain area by itself. The cleaning of the floor referred to herein includes inhaling dust (including a foreign substance) on the floor or mopping the floor.

The robot cleaner 1 includes a cleaner body 10, suction means 20, sensing means 60, and dust collecting means 40.

The body 10 is a portion that forms an outer appearance of the robot cleaner. Various electrical components may be disposed inside the body 10 such that the robot cleaner may operate.

The body 10 may include input means 11 capable of receiving a command of a user.

A controller 90 for controlling the robot cleaner 1 and driving means 30 for the traveling of the robot cleaner 1 are disposed inside the cleaner body 10. The robot cleaner 1 may be moved or rotated from front to back and side to side by the driving means 30.

The driving means 30 includes main wheels 31 and an auxiliary wheel 32.

The main wheels 31 are respectively disposed at both sides of the body 10, and are constructed to be rotatable in one direction or the other direction in response to a control signal of the controller. The main wheels 31 may be constructed to be driven independently of each other. For example, the main wheels 31 may be driven by different motors.

The auxiliary wheel 32 supports the body 10 together with the main wheels 31, and assists the robot cleaner 1 in traveling by the main wheels 31. Such an auxiliary wheel 32 may also be disposed in the suction means 20 to be described later.

As described above, the controller controls driving of the driving means 30, so that the robot cleaner 1 autonomously travels on the floor.

In one example, the body 10 is equipped with a battery (not shown) that supplies power to the robot cleaner 1. The battery is rechargeable and is able to be detachably mounted on one surface of the body 10.

The suction means 20 is disposed at one side of the body 10 to suck air containing dust.

The suction means 20 may be detachably coupled to the body 10 or integrally formed with the body 10. When the suction means 20 is removed from the body 10, a wet cleaning module 70 may be detachably coupled to the body 10 in place of the removed suction means 20. Therefore, when the user wants to remove dust on the floor, the suction means 20 may be mounted on the body 10, and when the user wants to mop the floor, the wet cleaning module may be mounted on the body 10.

However, the present disclosure may not be limited thereto, and the robot cleaner according to one embodiment may be in a form in which both the suction means 20 and the wet cleaning module 70 are integrally formed with each other.

The dust collecting means 40 is a component that provides a suction force such that dust may be sucked by the suction means 20. The dust collecting means 40 may play a role of separating dust from sucked air, storing the dust, and discharging clean air to the outside of the robot cleaner again. The suction means 20 may increase or decrease the suction force under the control of the controller. Specifically, the suction force of the suction means 20 may be adjusted based on information on a floor surface on which the robot cleaner travels.

The dust collecting means 40 may include a driving motor (not shown). A negative pressure may be generated inside the robot cleaner and the dust, the foreign substance, or the like may flow into the robot cleaner via the driving motor equipped in the dust collecting means 40.

The suction means 20 may be equipped with an agitator 21. Depending on a weight or a type of dust, it may be difficult to remove the dust only with the suction force of the dust collecting means 40. Therefore, the agitator 21 may be equipped for effective dust removal.

Specifically, the agitator 21 may rotate on the surface on which the robot cleaner 1 is traveling so as to scatter dust on the floor and induce the suction of duct into the suction means 20. When dust is scattered, dust may easily flow into the robot cleaner by the suction force of the dust collecting means 40.

Operation of the agitator 21 may be controlled via an agitator motor (not shown) disposed within the suction means 20. A degree of rotation of the agitator 21 may vary depending on a type and a material of the floor surface.

The sensing means 60 is disposed on the body 10. As shown, the sensing means 60 may be disposed at one side of the body 10 where the suction means 20 is located, that is, at a front side of the body 10. This may be to prevent collision with an obstacle when the robot cleaner 1 travels.

The sensing means 60 may additionally perform another sensing function other than such sensing functions.

The sensing means 60 may include a camera 63. In this regard, the camera may mean a two-dimensional camera sensor. The camera 63 is disposed on one surface of the robot cleaner and acquires image information related to surroundings of the body during the traveling.

An image input by an image sensor equipped in the camera 63 is converted to generate image data in a predetermined format. The generated image data may be stored in a memory 12.

In one example, the sensing means 60 may include a three-dimensional depth camera (3D depth camera) that calculates a distance between the robot cleaner and an object-to-be-captured.

Specifically, the depth camera is able to capture a 2D image related to the surroundings of the body and generate a plurality of 3D coordinate information corresponding to the captured 2D image.

In one embodiment, the depth camera may include a light source 61 that emits light and a sensor 62 that receives the light emitted from the light source 61, and may measure the distance between the robot cleaner and the object-to-be-captured by analyzing the image received from the sensor 62. Such 3D camera sensor may be a 3D camera sensor in a time of flight (TOF) scheme.

In another embodiment, the depth camera may include the light source 61 that emits an infrared pattern together with the sensor 62, that is, an infrared pattern emitter. The sensor 62 may measure the distance between the robot cleaner and the object-to-be-captured by capturing a shape of projection of the infrared pattern emitted from the infrared pattern emitter onto the object-to-be-captured. Such 3D camera sensor may be a 3D camera sensor in an infrared (IR) scheme.

In another embodiment, the depth camera may be equipped with two or more conventional cameras that acquire the 2D images, and may be formed in a stereo vision scheme that generates the 3D coordinate information by combining the two or more images acquired from the two or more cameras.

The robot cleaner 1 may include a side brush module 50. The side brush module 50 may play a role of scattering dust on the floor surface like the agitator 21 described above.

The side brush module 50 may be coupled to the body 10 and may include a plurality of side brush modules on the body 10.

In addition, the side brush module 50 is preferably located adjacent to the suction means 20 as shown in FIG. 2.

The scattering of the dust on the floor surface is for removing dust efficiently. Therefore, when the side brush module 50 is disposed at a considerable distance from the suction means 20, it is not preferable because the side brush module 50 is not able to significantly affect a cleaning efficiency.

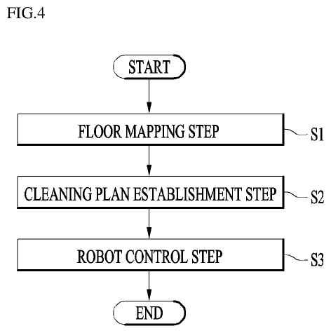

FIG. 4 is a diagram showing a method for controlling a robot cleaner according to one embodiment.

Hereinafter, the method for controlling the robot cleaner will be described with reference to FIG. 4.

The method for controlling the robot cleaner according to one embodiment may include a floor mapping step (S1), a cleaning plan establishment step (S2), and a robot control step (S3).

The floor mapping step (S1) is a step in which the robot cleaner travels and collects the information on the floor surface. In this regard, the information on the floor surface may be collected by the sensing means 60 including the light source and the sensor described above.

Therefore, the cleaning may be performed efficiently by identifying an area-to-be-intensively-cleaned or an area-to-be-climbed by the robot cleaner in advance by determining a curvature, a height, or the like of the floor, rather than roughly identifying a shape of the floor surface.

When the information on the floor surface is simply collected with only the camera 63, it may be difficult to establish a precise cleaning plan because of various factors such as an illuminance, a color of the floor surface, or the like.

The cleaning plan establishment step (S2) may be a step in which the cleaning plan of the robot cleaner is determined based on the information collected via the floor mapping step (S1).

The area-to-be-cleaned that is to be cleaned by the robot cleaner may not be an empty space. For example, there may be an area that is difficult for the user to reach due to arrangement of furniture, or there may be an area where dust must be removed with a strong suction force such as a carpet. In addition, there may be an area where wet cleaning is impossible due to arrangement of electric wires and the traveling of the robot cleaner is interrupted.

For the efficient cleaning, it is important to determine how the robot cleaner travels and performs the cleaning in various situations as described above.

The robot control step (S3) is a step of controlling various components of the robot cleaner to perform the cleaning based on the plan determined in the cleaning plan establishment step (S2).

The robot control step (S3) is a step of controlling the robot cleaner such that the robot cleaner may perform an appropriate operation in a specific area while traveling in the area-to-be-cleaned. The robot control step (S3) may be performed by the controller 90. The controller 90 controls the robot cleaner such that the robot cleaner may perform the appropriate operation based on the cleaning plan.

Details thereof will be described later.

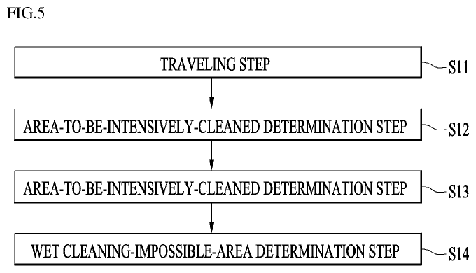

FIG. 5 is a diagram specifically showing a floor mapping step of a method for controlling a robot cleaner according to one embodiment.

The floor mapping step (S1) may include a traveling step (S11), an area-to-be-intensively-cleaned determination step (S12), a cleaning-impossible-area determination step (S13), and a wet cleaning-impossible-area determination step (S14).

The traveling step (S11) is a step in which the robot cleaner travels in the area-to-be-cleaned. The traveling step (S11) may be always performed during the floor mapping step (S1).

The area-to-be-intensively-cleaned determination step (S12) may be a step of determining areas requiring high suction force or areas with high RPM of the agitator 21 for the cleaning of a floor surface in the area-to-be-cleaned, distinguished from the remaining areas.

That is, in one embodiment of the present disclosure, in the area-to-be-intensively-cleaned determination step (S12), the area-to-be-intensively-cleaned in which the suction force of the robot cleaner required for the cleaning is set to be greater than that in the remaining areas may be determined in a manner of being distinguished from the remaining areas.

The area-to-be-intensively-cleaned may include at least one of a corner, a crevice, and a carpet of the area-to-be-cleaned, and may be distinguished from the remaining areas excluding the area-to-be-intensively-cleaned. However, the present disclosure is not limited thereto. The user may separately set an area that requires the intensive cleaning as needed.

Dust tends to accumulate at the corner or the crevice of the area-to-be-cleaned. In addition, there is a high possibility that there is dust that has been left unattended for a long time at the corner or the crevice. Therefore, when cleaning the corner or the crevice, the suction force of the dust collecting means 40 may be greatly increased via the robot control step (S2). In addition, the RPM of the agitator 21 may also be increased, so that the cleaning may be effectively performed.

The carpet may be easily accessible to the user, but may require a great suction force of the dust collecting means 40 depending on a material of the carpet. This is because dust located between piles of the carpet may be difficult to be removed due to the piles. Therefore, even in the case of the carpet, it may be controlled that the suction force of the dust collecting means 40 is greatly increased and the RPM of the agitator 21 is increased.

When the controller 90 always keeps the suction force of the dust collecting means 40 high or the RPM of the agitator 21 high, there is no problem in terms of cleanliness, but battery consumption may increase significantly. In addition, when the suction force is excessively increased even in a case in which it is sufficient to maintain the suction force sufficient to clean a general floor surface, it is disadvantageous in terms of the cleaning efficiency. It may also cause other problems such as noise and rapid aging.

The cleaning-impossible-area determination step (S13) is a step of determining a cleaning-impossible-area in which the cleaning of the robot cleaner is limited in the area-to-be-cleaned.

The cleaning-impossible-area may include at least one of a travel-impossible-area in which the robot cleaner is not able to travel and an obstacle area, which is an area in which an obstacle restricting an operation of the side brush module is disposed.

In a specific example, the cleaning-impossible-area may include an area with a step that is too large for the robot cleaner to travel. This is because, when the traveling of the robot cleaner is restricted, travel to another area after cleaning the corresponding area is restricted.

Even where the carpet is placed, when a length of the pile of the carpet is equal to or greater than a predetermined length, the corresponding area may be determined as an area not able to be climbed by the robot cleaner.

In addition, as an example, an area in which the obstacles, such as the electric wires or the like, that interfere with the traveling of the robot cleaner or the operation of the side brush module 50 are concentrated may be determined as the cleaning-impossible-area.

When the cleaning-impossible-area is determined, the cleaning-impossible-area may be excluded from the area-to-be-cleaned. When the area in which the traveling of the robot cleaner is restricted or the operation of the side brush module 50 is restricted as described above is also determined as the area-to-be-cleaned, it may be difficult for the robot cleaner to perform the cleaning as planned.

In addition, even when the cleaning of the robot cleaner is normally performed, in an area where a large number of electric wires or the like are disposed, the electric wires may get caught in the side brush module 50 and cause the side brush module 50 to malfunction. In addition, a case in which power to electronic products existing in the area-to-be-cleaned is unexpectedly cut off may occur.

The wet cleaning-impossible-area determination step (S14) is a step of determining an area that is not able to be cleaned via the wet cleaning module 70 of the robot cleaner.

A wet cleaning-impossible-area literally means an area in which the wet cleaning is impossible in the area-to-be-cleaned.

For example, the area in which the electric wires are placed may be the wet cleaning-impossible-area. In addition, the area in which the carpet is placed may be the wet cleaning-impossible-area.

When the wet cleaning is performed in the area in which the electric wires are placed, safety accidents such as short circuits and electric leakage may occur. In addition, when the wet cleaning is performed on the carpet, hygienic problems such as contamination of the carpet and generation of mold may occur.

The area-to-be-intensively-cleaned determination step (S12), the cleaning-impossible-area determination step (S13), and the wet cleaning-impossible-area determination step (S13) do not have to be performed in the order shown in FIG. 4.

That is, when the cleaning-impossible-area is determined, it is not necessary to determine whether the cleaning-impossible-area is the wet cleaning-impossible-area or the area-to-be-intensively-cleaned. Therefore, the cleaning-impossible-area determination step (S13) may be performed first, and then the area-to-be-intensively-cleaned determination step (S12) and the wet cleaning-impossible-area determination step (S14) may be performed.

When the floor mapping step (S1) is terminated, information on the area-to-be-cleaned may be stored in the memory 12. The information on the area-to-be-cleaned may be stored together with a time when floor mapping was performed.

The floor mapping step (S1) may be performed whenever the cleaning is performed. However, the present disclosure may not be limited thereto, and the floor mapping step (S1) may be skipped and the cleaning may be performed using existing information based on a user's input or previously input settings.

This is because, in some cases, a blanket or the like may be temporarily placed at night and a table or the like may be temporarily placed during mealtime in the area-to-be-cleaned.

Therefore, the robot cleaner may determine a more efficient cleaning route by storing floor mapping information differently based on time.

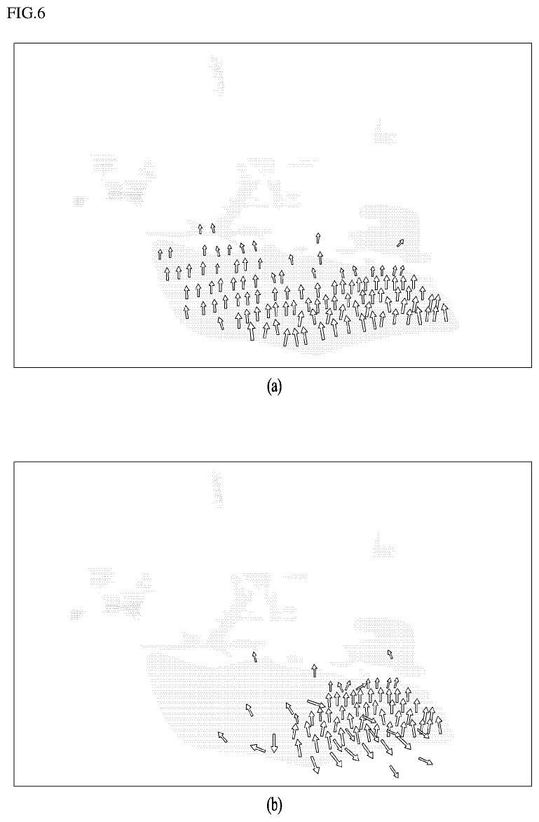

FIG. 6 is a diagram showing an example of determining a carpet on a floor surface.

(a) in FIG. 6 is a diagram showing that the sensing means has sensed a flat floor surface, and (b) in FIG. 6 is a diagram showing that the sensing means has sensed the carpet.

Hereinafter, a method for distinguishing between the flat floor surface and the carpet by the robot cleaner will be described with reference to (a) and (b) in FIG. 6.

When a normal vector is extracted from the flat floor surface, the uniform normal vector is extracted at any point. Specifically, the normal vectors extracted from respective points may be extracted in directions parallel to each other.

On the other hand, referring to (b) in FIG. 6, when the robot cleaner extracts normal vectors of the area in which the carpet is placed, the normal vectors are not uniformly extracted unlike in (a) in FIG. 6.

This is because the piles of the carpet are not arranged parallel to the ground. That is, because it is common for the piles to be positioned obliquely to the ground, the normal vectors at the respective points in the area in which the carpet is placed are extracted so as to cross each other or so as to be directed in different directions.

Therefore, the information on the floor surface may be acquired by extracting the normal vector of the floor surface.

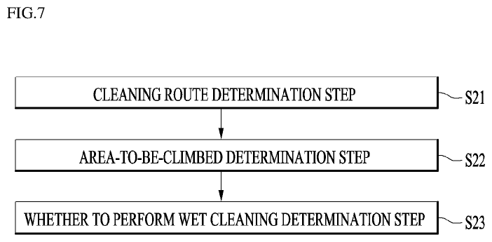

FIG. 7 is a diagram showing a cleaning plan establishment step of a robot cleaner according to one embodiment.

The cleaning plan establishment step (S2) may include a cleaning route determination step (S21), an area-to-be-climbed determination step (S22), and a whether to perform wet cleaning determination step (S23).

The cleaning route determination step (S21) is a step for determining which route to perform the cleaning based on the information collected via the floor mapping step (S1).

After the floor mapping step (S1) is finished, a magnitude and a shape of the area-to-be-cleaned may be determined. In addition, the cleaning-impossible-area and the wet cleaning-impossible-area may also be determined as described above.

Therefore, the robot cleaner may determine the cleaning route considering the collected information.

Specifically, an area determined as the cleaning-impossible-area may be excluded from the cleaning route. The cleaning-impossible-area may be determined for various reasons as described above. When the area is determined as the cleaning-impossible-area, it is obvious that the robot cleaner is not able to smoothly clean the corresponding area, so that it is desirable for the robot cleaner to perform the cleaning by avoiding the cleaning-impossible-area.

Therefore, the controller 90 may plan the cleaning route avoiding the cleaning-impossible-area.

In addition, the efficient cleaning route may be set based on a position of the area-to-be-climbed, which will be described later. For example, it may be determined that the cleaning is performed within a short period of time by setting a route that minimizes climbing.

In addition, when many areas-to-be-climbed are distributed in a specific area of the area-to-be-cleaned, the robot cleaner may be controlled to clean the specific area lastly.

The area-to-be-climbed determination step (S22) is a step for determining whether to climb on a non-thick carpet or in an area with a step that is able to be climbed by the robot cleaner. In other words, this is a step where the robot cleaner determines the area-to-be-climbed area where the climbing is to be performed while traveling in the area-to-be-cleaned.

The climbing may be performed smoothly only when the RPM of the driving means 30 of the robot cleaner is increased. In one example, the climbing may be performed with only an RPM necessary for the travel of the robot cleaner, but it is preferable to temporarily increase the RPM for efficient cleaning.

When the area-to-be-climbed is determined based on the previously collected information, the cleaning may be performed while the robot cleaner travels smoothly by temporarily increasing the RPM of the driving means 30 only in the corresponding area. When the RPM is excessively increased on the flat floor, a travel speed may increase to a point at which the cleaning is not able to be performed and power may be consumed unnecessarily.

Accordingly, it may be controlled that the RPM of the driving means 30 is increased only in the area in which the climbing is required based on the information previously collected via the robot control step (S3).

The whether to perform wet cleaning determination step (S23) is a step of determining whether to perform the wet cleaning in the remaining area of the area-to-be-cleaned excluding the wet cleaning-impossible-area when the area in which the wet cleaning is impossible is determined via the wet cleaning-impossible-area determination step (S14).

Whether to perform the wet cleaning may be performed periodically or non-periodically based on a user input. In addition, whether to perform the wet cleaning may be automatically determined via preset settings.

For example, when it is set to perform the wet cleaning every 3 cleanings, the robot cleaner may perform the wet cleaning every 3rd cleaning. When it is set to perform the wet cleaning for every cleaning performed between 1:00 PM and 3:00 PM, the robot cleaner may perform the wet cleaning when the robot cleaner is operated at a preset time.

Although the present disclosure has shown and described with respect to the particular embodiment, to the extent not departing from the technical spirit of the present disclosure provided by the following claims, it will be apparent to those of ordinary skill in the art that the present disclosure may be variously improved and changed.

### REFERENCE NUMERALS

1: robot cleaner

10: body

11: input means

12: memory

20: suction means

21: agitator

30: driving means

31: main wheel

32: auxiliary wheel

40: dust collecting means

50: side brush module

60: sensing means

61: light source

62: sensor

63: camera

70: wet cleaning module

90: controller

What is claimed is:

1. A method for controlling a robot cleaner, the method comprising:
a floor mapping step for the robot cleaner to collect information on a floor surface while traveling in an area-to-be-cleaned;
a cleaning plan establishment step for determining a cleaning plan of the robot cleaner based on the collected information on the floor surface; and
a robot control step for controlling the robot cleaner to perform cleaning while traveling based on the cleaning plan when the cleaning plan is determined.

2. The method of claim 1, wherein, in the floor mapping step, the information on the floor surface is collected by sensing means including a light source for irradiating light and a sensor for sensing reflection of the light irradiated from the light source.

3. The method of claim 1, wherein the floor mapping step includes an area-to-be-intensively-cleaned determination step for determining, in the area-to-be-cleaned, an area-to-be-intensively-cleaned here a suction force of the robot cleaner is set to be greater than in remaining areas.

4. The method of claim 3, wherein the area-to-be-intensively-cleaned includes at least one of a corner, a crevice, and a carpet existing in the area-to-be-cleaned.

5. The method of claim 3, wherein, in the robot control step, the robot cleaner is controlled such that an RPM of an agitator equipped in suction means and inducing suction of dust is higher in the area-to-be-intensively-cleaned than in the remaining areas.

6. The method of claim 1, wherein the floor mapping step includes a cleaning-impossible-area determination step for determining a cleaning-impossible-area where the cleaning of the robot cleaner is limited in the area-to-be-cleaned.

7. The method of claim 6, wherein the robot cleaner includes suction means for sucking dust on the floor surface and a side brush module for scattering dust on the floor surface,
wherein the cleaning-impossible-area includes at least one of a travel-impossible-area where the robot cleaner is not able to travel and an obstacle area where an obstacle limiting operation of the side brush module is disposed.

8. The method of claim 6, wherein the cleaning plan establishment step includes a cleaning route determination step for generating a cleaning route of the robot cleaner,
wherein, when the cleaning-impossible-area is determined, the cleaning-impossible-area is controlled to be excluded when the cleaning route of the robot cleaner is generated in the cleaning plan establishment step.

9. The method of claim 1, wherein the robot cleaner includes a wet cleaning module capable of performing wet cleaning,
wherein the floor mapping step includes a wet cleaning-impossible-area determination step for determining a wet cleaning-impossible-area, an area where the wet cleaning is impossible.

10. The method of claim 9, wherein the wet cleaning-impossible-area includes at least one of an area with electric wires and an area with a carpet.

11. The method of claim 1, wherein the cleaning plan establishment step includes a cleaning route determination step for generating a cleaning route of the robot cleaner,
wherein the cleaning route is newly determined each time the cleaning is performed.

12. The method of claim 11, wherein the cleaning route is determined differently depending on a cleaning time slot.

13. The method of claim 1, wherein the cleaning plan establishment step includes an area-to-be-climbed determination step for determining an area-to-be-climbed, an area to be climbed by the robot cleaner while traveling, in the area-to-be-cleaned.

14. The method of claim 1, wherein the cleaning route determination step determines a cleaning route based on a location of the area-to-be-climbed.

15. A robot cleaner comprising:
a body for forming an outer appearance of the robot cleaner;
suction means coupled to the body and sucking dust from a floor surface;
driving means coupled to the body and constructed to allow the body to move;
sensing means including a three-dimensional depth camera (3D depth camera) for calculating a distance to an object-to-be-captured and disposed on the body; and
a controller configured to control operation schemes of the suction means and the driving means,
wherein the controller is configured to adjust a suction force of the suction means and an RPM of the driving means based on information on the floor surface.
